(19) United States
(12) Patent Application Publication
(10) Pub. No.: US 2025/0368404 A1
(43) Pub. Date: Dec. 4, 2025

(54) LIQUID FLOW STABILIZING STOPPER

(71) Applicant: PMI South America Consumer Goods LTDA, Rio de Janeiro (BR)

(72) Inventor: Alex MONTEIRO BOTELHO, Rio de Janeiro (BR)

(21) Appl. No.: 18/869,717

(22) PCT Filed: May 26, 2023
(86) PCT No.: PCT/BR2023/050163

§ 371 Date: Nov. 26, 2024

(30) Foreign Application Priority Data
May 27, 2022 (BR) 2020220104331

(51) Int. Cl. B65D 47/24; B65D 39/08

(52) U.S. Cl. CPC B65D 47/246; B65D 39/08

(57) ABSTRACT

The present invention refers to a liquid flow stabilizer stopper 1 arranged to be associated to openings of bottles, thermos flasks and similar containers. The thread 1 is comprised of a stopper body 3 which presents a closed lower end 2 and an open upper end 4 for the outflow of liquid. The stopper body 3 is endowed circumferentially with openings 6, through which liquid can flow to the inside of the stopper 1. The stopper 1 is partially hollow and endowed internally with a flow stabilizer bulge 8, which originates at the closed lower end 2 and projects longitudinally through the inside of the stopper 1, thus configuring an annular internal space 7 for the passage of liquid to the open upper end 4.

### TECHNICAL FIELD

The present invention refers to the technical field of stoppers for use in mouths of bottles and similar containers.

### DESCRIPTION OF THE STATE OF THE ART

The use of devices adapted to be associated to mouths of bottles, thermos flasks and similar containers is broadly known in the state of the art. Said devices may have a variety of different functions, such as closing/opening access of the liquid in the container to the outside in order to serve it, controlling the intensity of the flow of liquid or even making its flow more stable, reducing dripping and other undesirable effects. Everyday examples of devices of this type are spouts of sports bottles and nozzle stoppers in thermos flasks.

In this sense, document U.S. Pat. No. 8,056,745 (B2) discloses a stopper for thermos flasks the objective of which is to enable the user to serve liquid in a simple and practical way, dispensing with the need to remove the stopper for such. The stopper includes a mechanism that includes a drive button, which, upon being pressed, raises the lid, whereby enabling the liquid to traverse its inside and be served. The stopper is associated to the mouth of the thermos flask by threading.

Document EP2796078 (B1), in turn, defines a stopper combination for bottles with a two-part arrangement, consisting of an outer plug encased in the mouth of the bottle and an inner plug encased in the outer plug. The outer and inner plugs are threaded together.

A major drawback found in the traditional solutions is the instability and the turbulence of the flow generated upon serving beverages with said devices, generating vortexes and undesirable dripping. This phenomenon may not be so harmful in some day-to-day applications, such as drinking chilled water from a sports bottle, wherein the liquid is not hot and there is no need for the trajectory of the liquid to be highly precise on flowing out of the bottle.

However, in certain applications, for example, in serving coffee, tea or hot water from a thermos flask, it is crucial that the hot liquid should not spill on the user, which could cause damage to health. It is also important that the flow of the liquid to the container of arrival be as stable as possible to avoid losses of liquid. Therefore, the solution must be able to generate a stable and laminar flow, thus avoiding turbulence, vortexes and undesirable dripping, whereby preventing losses of liquid and damage to the user.

It was also noted that various stoppers from the state of the art present unnecessarily complicated constructions involving a high number of parts, making manufacturing and the end price of the product more costly, as well as making it harder to assemble and disassemble.

Another drawback detected is the lack of concern with the heat exchange that naturally occurs between the liquid and the parts of the stopper. When the bottle is tilted, the hot liquid contained on its inside comes into physical contact with parts of the stopper that are at a cooler temperature, triggering the heat exchange between the hot liquid and the stopper. This effect is undesirable, as the intention of the user is precisely to utilize all the heat from the liquid for preparing his/her beverage.

### OBJECTIVES OF THE INVENTION

The objective of the present invention is to remedy the shortcomings detected in known stoppers. A first objective to be achieved is that of providing a stopper for coupling on mouths of bottles, thermos flasks and the like, that is easy to manufacture and assemble on and disassemble from the container, and easy to operate.

Another objective to be achieved is to assure that the flow of liquid generated upon serving, that is, when tilting the container, that it be stable, laminar and precise, thus avoiding the occurrence of instabilities, vortexes, splashing, dripping and poor flow aiming. This is highly important so as to avoid potential waste of the liquid that does not fall into the container of destination, as well as injury to the user in cases of undesirable contact with hot liquid.

There is a further objective for minimizing the heat exchange between the hot liquid and the stopper in the act of serving, entailing maximum utilization of the heat from the liquid.

### BRIEF DESCRIPTION OF THE INVENTION

The objectives of the present invention are achieved by means of a liquid flow stabilizer stopper arranged to be associated to openings of bottles, thermos flasks and similar containers. The stopper is comprised of a stopper body that presents a closed lower end and an open upper end for the liquid outflow. The stopper body is endowed circumferentially with openings, through which liquid can flow to the inside of the stopper, which is partially hollow and endowed internally with a flow stabilizer bulge. The flow stabilizer bulge originates at the closed lower end and projects longitudinally through the inside of the stopper, thus configuring an annular internal space for the passage of liquid to the open upper end. The openings of the stopper body are oblong in shape.

The stopper body is endowed externally, at least in part of its length, with a thread fillet, which corresponds to the internal thread of a mouth of the container to which the liquid flow stabilizer stopper is arranged to be associated by threading. At least one gasket externally and circumferentially to the stopper body can be provided.

The flow stabilizer bulge comprises internally a thermally-insulating material which may be a block of polystyrene, of polyurethane or the like.

### BRIEF DESCRIPTION OF THE DRAWINGS

The present invention will now be described based on the drawings.

FIG. 1 illustrates the liquid flow stabilizer stopper of the present invention in a front view, enabling the visualization of its main outer characteristics; and

FIG. 2 represents a cutaway view of the liquid flow stabilizer stopper, illustrating elements inside the stopper.

### DETAILED DESCRIPTION OF THE DRAWINGS

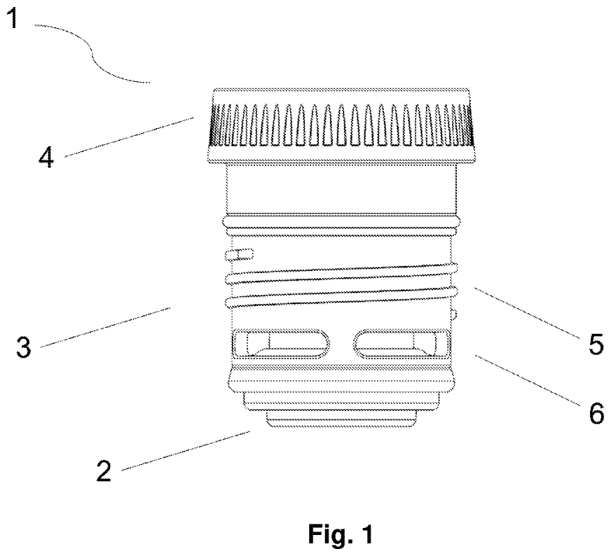

As can be seen in FIG. 1, the liquid flow stabilizer stopper 1 of the present invention is comprised of a stopper body 3 substantially cylindrical in shape, which presents a closed lower end 2 and an open upper end 4, through which the liquid can flow out of the liquid flow stabilizer stopper 1. The stopper body 3 is manufactured of polymer material, such as polypropylene, and the closed lower end 2 is made of stainless steel, and can also be made of the same material as the stopper body 3.

The outer shape of the liquid flow stabilizer stopper 1 is projected such that the stopper body 3 encases into the mouth of an appropriate container, such as a bottle or a thermos flask. In order to assure optimal coupling of the liquid flow stabilizer stopper 1 to the bottle, enabling easy assembly and disassembly and good sealing, a thread fillet 5 is formed along a given length of the outer face of the stopper body 3. This thread fillet 5 corresponds to the internal thread of the mouth of the bottle with which the liquid flow stabilizer stopper 1 will work. In order to assure even better sealing of the liquid flow stabilizer stopper 1 relative to the bottle mouth, gaskets outside the stopper body 3 can be used.

The stopper body 3 is also endowed circumferentially, in its lower portion, with oblong-shaped openings 6 that give access to the inside of the stopper 1. These openings 6 communicate the inside of the liquid flow stabilizer stopper 1 to the inside of the bottle, enabling the entry of liquid into the stopper 1. Therefore, the path taken by the liquid upon serving, from the bottle to the outflow thereof, is entering into the stopper 1 through the openings 6 of the stopper body 3, through the inside of the liquid flow stabilizer stopper 1, flowing out through its open upper end 4.

A person skilled in the art will perceive that it can be advantageous to provide an adjustment mechanism to vary the size of the openings 6 of the stopper body 3, whereby enabling an adjustment of the liquid flow from the bottle to the inside of the stopper 1.

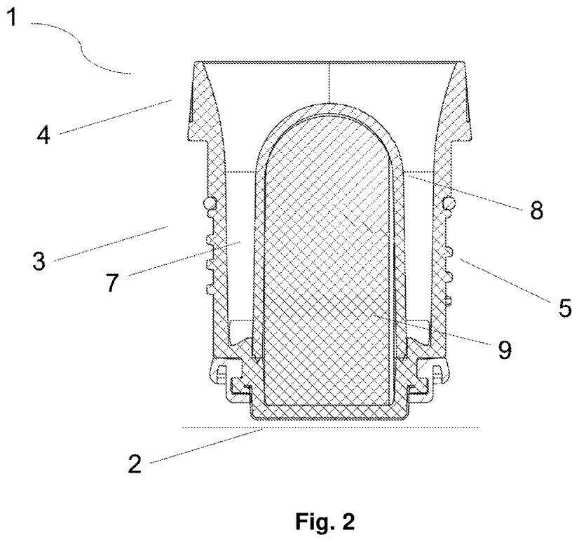

FIG. 2, which is a cutaway view of the liquid flow stabilizer stopper 1, illustrates internal characteristics not shown in FIG. 1, such as the fact that its inside is partially hollow.

Originating at the closed lower end 2, internally to the stopper 1, there is a flow stabilizer bulge 8 which extends longitudinally through the inside of the stopper 1, coaxially thereto, extending towards the open upper end 4. This flow stabilizer bulge 8 is substantially cylindrical in shape and, at its end opposite the closed lower end 2, that is, at the end nearest to the open upper end 4, it ends in a substantially convex shape. Therefore, the non-hollow portion of the interior of the liquid flow stabilizer stopper 1 is given mostly by the volume of the flow stabilizer bulge 8.

An annular internal space 7 is thus configured inside the liquid flow stabilizer stopper 1, given by the empty space between the stopper body 3 and the flow stabilizer bulge 8. The total empty internal volume of the stopper 1, which represents the inner portion of the stopper 1 through which the liquid can flow, is given by the annular internal space 7 and by the empty volume of the stopper 1 in the region of the open upper end 4.

With this arrangement, after the entry of the liquid from the bottle into the stopper 1 through the openings 6, the liquid flows through the inside of the stopper body 3 through the annular internal space 7, flowing along the stopper 1 in contact with the inner wall of the stopper body 3 and the outer surface of the flow stabilizer bulge 8. After flowing through the annular internal space 7, the liquid arrives at the region of the open upper end 4 and finally leaves the liquid flow stabilizer stopper 1. It was established that this geometry has a positive influence on the flow regime of the liquid leaving the bottle, conditioning a laminar, precise and reliable flow, without the occurrence of turbulence and splashing. It also produces the effect of centralizing the flow.

In the hypothesis that a stopper arrangement were designed without this internal flow stabilizer bulge 8, the liquid flow generated in the act of serving would generate splashes and an unstable stream of liquid having vortexes, creating the risk that part of the liquid might not reach its final destination (for example, the mate gourd, the coffee cup, etc.), generating waste, or even the risk of contact of hot beverage with the skin of the user, potentially harmful to health.

The flow stabilizer bulge 8 may present internally a thermally-insulating material 9, such as a block of polystyrene, of polyurethane or the like. The presence of the flow stabilizer bulge 8 inside the liquid flow stabilizer stopper 1 implies greater contact of the liquid with parts of the stopper 1 during its path to the bottle outflow, which entails undesirable heat exchanges between the hot liquid and the parts of the stopper, which are at a lower temperature. This thermally-insulating material 9 is therefore intended to reduce to a minimum said heat exchanges, such that the temperature of the liquid on leaving the bottle is substantially identical to its original temperature, further enhancing the user's experience.

A person skilled in the art will easily perceive that the dimensions of the distinct elements that make up the liquid flow stabilizer stopper 1 of the present invention, as well as their constituent materials and particular geometries, may be varied pursuant to the project requirements, type of container to which the stopper will be encased, etc. For example, the total length of the liquid flow stabilizer stopper 1 may be about 72 mm, the total length of the combination formed by the flow stabilizer bulge 8 and closed lower end 2 may be about 63.5 mm, the inner diameter of the stopper body 3 may be about 40.5 mm and the outer diameter of the flow stabilizer bulge 8 may be about 31 mm.

1. A liquid flow stabilizer stopper arranged to be associated to openings of bottles, thermos flasks and similar containers, comprising:
a stopper body comprising a closed lower end and an open upper end for the outflow of liquid, wherein the stopper body is endowed circumferentially with openings, through which liquid can flow to an inside of the stopper, wherein the stopper is partially hollow and endowed internally with a flow stabilizer bulge originating at the closed lower end and projecting longitudinally through the inside of the stopper, whereby configuring an annular internal space for the passage of liquid to the open upper end.

2. The stopper of claim 1, wherein the stopper body is endowed externally, at least in part of its length, with a thread fillet, which corresponds to the internal thread of a mouth of the container to which the liquid flow stabilizer stopper is arranged to be associated by threading.

3. The stopper of claim 1, characterized in that wherein the flow stabilizer bulge comprises internally a thermally-insulating material.

4. The stopper of claim 3, wherein the thermally-insulating material is a block of polystyrene, of polyurethane or the like.

5. The stopper of claim 1, wherein the openings of the stopper body are oblong in shape.

6. The stopper of claim 1, wherein at least one gasket is provided externally.
